(19) United States
(12) Patent Application Publication
(10) Pub. No.: US 2006/0125248 A1
(43) Pub. Date: Jun. 15, 2006

(54) Door locking mechanism

(76) Inventors: Peter Heeley, POWYS (GB); Philip David Jones, Shropshire (GB)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 10/521,039

(22) PCT Filed: Jul. 11, 2003
(86) PCT No.: PCT/GB03/03003

§ 371 Date: Nov. 14, 2005

(30) Foreign Application Priority Data
Jul. 12, 2002 (GB) 0216354.1

(51) Int. Cl. E05B 3/00

(52) U.S. Cl. 292/336.3

(57) ABSTRACT

The locking mechanism includes a lever handle having a fluted passageway for fitting to an adjacent end of a latch spindle. The passageway allows the handle to turn relatively to the latch spindle in opposite directions through a predetermined angle of movement. At one end of this angle of movement, the handle is in a horizontal rest position and is engageable with the latch spindle for turning the spindle in a direction to withdraw the latch bolt from its latching position, and at the opposite end, the handle is in a lifted locking position and is engageable with the spindle to prohibit turning thereof in the opening direction. At the locking position, a locking member slidably mounted in the handle and controlled by a trigger part, extending behind the lever part of the handle is engageable in one of a pair of retainer holes depending on the handing of the lever handle.

### FIELD OF THE INVENTION

The present invention relates to a locking mechanism for use with the latch mechanism of a door, gate, window or other closure member (hereinafter referred to generally as a door) which latches the door in its closed position. More particularly, the locking mechanism is designed for use with such a latch mechanism which is releasable to enable opening of the door by turning of a handle on either side of the door.

### BACKGROUND OF THE INVENTION

Door latch mechanisms typically include a spring loaded latch bolt which is resiliently urged outwardly of the mechanism into a projecting, latching position in which the latch bolt is engageable with a retainer or catch on an adjacent door jamb to latch the door in its closed position. The latch bolt is withdrawn to permit opening of the door by turning of a square section latch spindle or bar which projects from opposite sides of the latch mechanism and the door and which may be turned by handles fitted to opposite ends of the latch spindle. The handles may be knobs or lever arms. If a door having such a latch mechanism is to be locked in its latched position, the door normally incorporates a separate key operated bolt. Alternatively, the latch mechanism may be fitted with one or both latch handles having a known locking mechanism which is actuated by a central push button or turnable button, or with a locking mechanism, such as described in WO-00/71841 or WO-02/72985 which is actuated by a turning action of the door handle, itself.

In another type of door locking mechanism described in GB-A-2,282,632, the locking mechanism comprises an L-shaped locking member which sits within a handle having a square section drive socket for fitting on to the adjacent end of a spindle. One limb of the L-shaped member has a head which projects from the handle to engage in a recess in a base rotatably mounting the handle so as to lock the handle to the base and prevent relative rotation between the handle and the base. The other limb of the locking member projects along the under surface of the arm of the handle and serves as a trigger which can be operated, as the arm is gripped, to slide the first limb into the arm and so release the mechanism for rotation relative to the base.

### SUMMARY OF THE INVENTION

An object of the present invention is to provide a locking mechanism for use with a door latch mechanism which allows the latch mechanism to be locked in its latching position from one side of the door so as to prohibit opening of the door by turning of the handle on the opposite side of the door.

The present invention includes a locking mechanism for a latch mechanism in which a latch spindle is turnable to move a latch bolt of the latch mechanism from its latching position, the locking mechanism comprising a rotatable handle having a passageway therein for fitting to an adjacent end of the latch spindle. The passageway allows the handle to turn relatively to the latch spindle in opposite directions through a predetermined arc of movement, at one end of which the handle is in a rest position and is engageable with the latch spindle for turning the spindle in a direction to move the latch bolt from its latching position, and at the opposite end of which the handle is in a locking position and is engageable with the spindle to prohibit turning thereof in the direction. A locking member is mounted on the handle and engageable, at the locking position of the handle, with a cooperating retainer.

In use, the locking mechanism according to the invention is installed on one side of the door, normally the inside, with the drive passageway of its handle fitted to the adjacent end of the latch spindle of the latch mechanism, which may be a spring loaded latch of a conventional type. On the opposite side of the door (the outside) the opposite end of the latch spindle may be fitted with a normal door handle which is fixed to that end of the latch spindle. As is conventional, either door handle may be operated so as to turn the latch spindle in the opening direction, thereby to withdraw the latch bolt from its latching position and enable opening of the door. However, when the door is to be locked on the inside, to prevent access from outside, the handle of the locking mechanism is turned from its rest position into the locking position and the locking member is actuated to engage it with the cooperating retainer, whereby the inside handle prohibits turning of the latch spindle, in the opening direction, by the handle on the outside and, hence, withdrawal of the latch bolt. To unlock the door to permit access from the outside, the locking member is released from engagement with the cooperating retainer and the handle of the locking mechanism is returned to its rest position.

The locking member may be slidably mounted in the handle and be selectively controlled so as to enable it to be engaged with and disengaged from the retainer. It may have control device/means projecting closely adjacent the handle in a convenient position for manual operation by a person gripping the handle. Preferably, the slidable locking member is resiliently urged into a projecting position for engagement with the retainer.

The locking mechanism may include a semi-circular guide defining an arc of movement for the projecting end of the locking member as the associated handle is turned in the opening direction from its rest position. The spring loaded latch bolt, as in a conventional latch mechanism, may serve to bias the handle of the locking mechanism towards the rest position. Alternatively, or in addition, the locking mechanism, itself, may include spring means for returning the handle to, and retaining it in, the rest position. The guide defining the arc of movement of the locking member may, for example, include a stop engageable with the projecting end of the locking member to define the rest position of the handle. The retainer with which the locking member is engaged to lock the handle against turning is then disposed in spaced relation to this stop in the opposite direction to that in which the handle is turned to withdraw the latch bolt so that, when the handle is in the locked position, this is clearly apparent.

Preferably, the retainer is a hole with which the slidable locking member is engageable to lock the handle and, hence, the latch spindle, against turning in the opening direction, and the stop is defined by one end of an arcuate groove along which the projecting end of the locking member moves when the locking mechanism is in its unlocked condition and its handle is turnable to withdraw the latch bolt.

In a preferred embodiment, the handle of the locking mechanism is in the form of a lever arm which, in the rest position of the locking mechanism, is substantially horizontal. The retainer is disposed along the arc of movement of the locking member above the stop defining the rest position, for example, at a position spaced between about 45° to 60° above the stop, and the lever handle is lifted to permit the locking member to engage with the cooperating retainer and lock the handle against turning. Such an arrangement provides a clear indication of when the locking mechanism is in its locked condition.

Conveniently, the handle is rotatably mounted in a base plate securable to the door and this base plate also mounts the retainer and, if provided, the stop and other means cooperating with the locking member. Also, conveniently, the retainer and the stop are duplicated at symmetrical positions on opposite sides of a substantially vertical plane through the axis of rotation of the handle so that the locking mechanism may selectively accommodate turning of the handle in either direction to effect withdrawal of the latch bolt.

In a preferred embodiment, the wall of the drive passageway in the handle of the locking mechanism for fitting to the latch spindle is axially fluted and has an internal cross-section comprising equally spaced axial ribs and grooves, the bottom of each of the grooves, in cross-section, having an arcuate periphery of a diameter substantially corresponding to the length of the diagonal of the square section of a cooperating latch spindle.

In a modification, the handle of the locking mechanism is designed to be fixed to the adjacent end of the latch spindle, for example, via a square drive passageway matching the square section of the spindle, and the handle for fitting to the latch spindle on the opposite side of the door has the drive passageway which enables the handle to turn relatively to the latch spindle in opposite directions through the predetermined arc of movement. In this case, the latch mechanism also has to be modified so as to permit rotation of the latch spindle with the handle of the locking mechanism when the handle is turned from its rest position to the locking position. This is readily achieved in a conventional latch mechanism in which the cam arrangement controlling the latch bolt is designed to be changed to reverse the direction of movement for withdrawing the latch bolt.

Hence, the present invention also includes a locking mechanism for a latch mechanism in which a latch spindle is turnable to move a latch bolt of the latch mechanism from its latching position. The locking mechanism includes a rotatable handle for fixing to an adjacent end of the latch spindle for turning the latter, a locking member mounted on the handle and engageable, in a locking position of the handle, with a cooperating retainer so as to prohibit turning of the handle and, hence, the latch spindle. The locking member in an unlocked, rest position being engageable with a stop member spaced from the locking position delimiting an arc of movement of the locking member over which the handle is turned from its rest position to move the latch bolt from its latching position, and an actuator for operating the locking member so as to permit the handle to be turned from the rest position to the locking position and the locking member to be engageable with the retainer.

### BRIEF DESCRIPTION OF THE DRAWINGS

The present invention may be more readily understood with reference to the accompanying drawings, in which:

FIG. 1 is a front elevational view of a door locking mechanism embodying the invention, with the handle shown in its normal position of use;

FIG. 2 is a side elevation of the mechanism of FIG. 1 with the handle positioned vertically downwards, so as to facilitate illustration of the mechanism;

FIG. 3 is a rear elevation of the mechanism shown in FIG. 1;

FIGS. 4, 5, 6 and 7 illustrate details of selected components of the door locking mechanism of FIG. 1;

FIGS. 8 and 9 are respectively front and rear elevations of a handle mechanism for use on the opposite side of a door fitted with the door locking mechanism of FIGS. 1 to 7 and showing the outside handle in its normal position;

FIG. 10 is a side elevation of the mechanism of FIGS. 8 and 9 with the handle positioned vertically downwards so as to facilitate illustration of the mechanism;

FIGS. 11 and 12 illustrate side and end elevations of a latch spindle specially designed for use with the locking mechanism of FIGS. 1-7 and the handle mechanism of FIGS. 8, 9 and 10;

FIG. 13 is a rear elevation of another embodiment of the outside handle mechanism;

FIGS. 14 and 15 are, respectively, rear and side elevations of yet another embodiment of the invention, the handle, which in normal use is positioned generally horizontal, being shown projecting vertically downwards in the side elevation to facilitate illustration of the locking mechanism;

FIGS. 16 and 17 are front and rear elevations of a further embodiment of the invention; and

FIGS. 18 and 19 are front and rear elevations of a handle mechanism for use on the opposite side of a door fitted on the inside with the door locking mechanism of FIGS. 16 and 17.

### DETAILED DESCRIPTION OF THE PREFERRED EMBODIMENTS

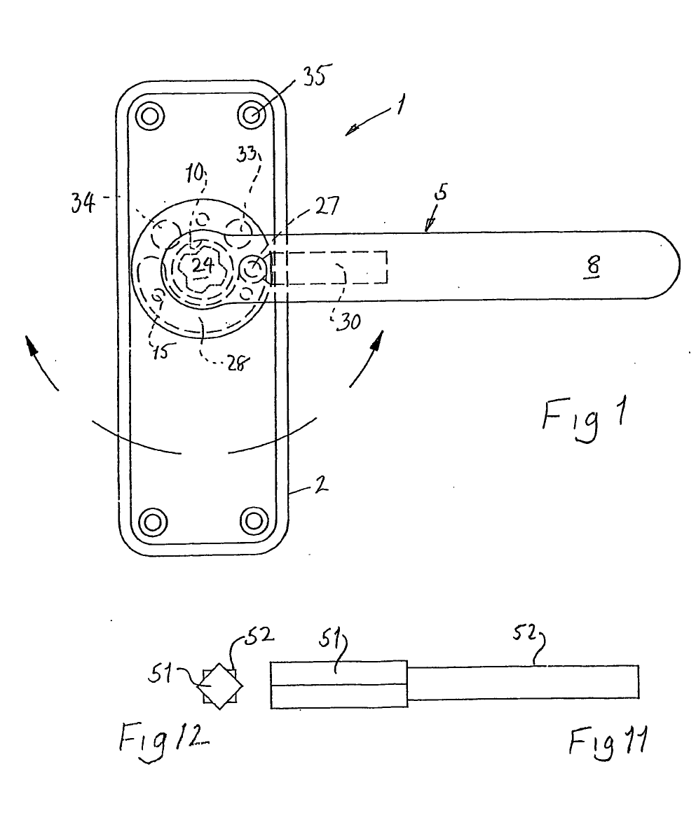

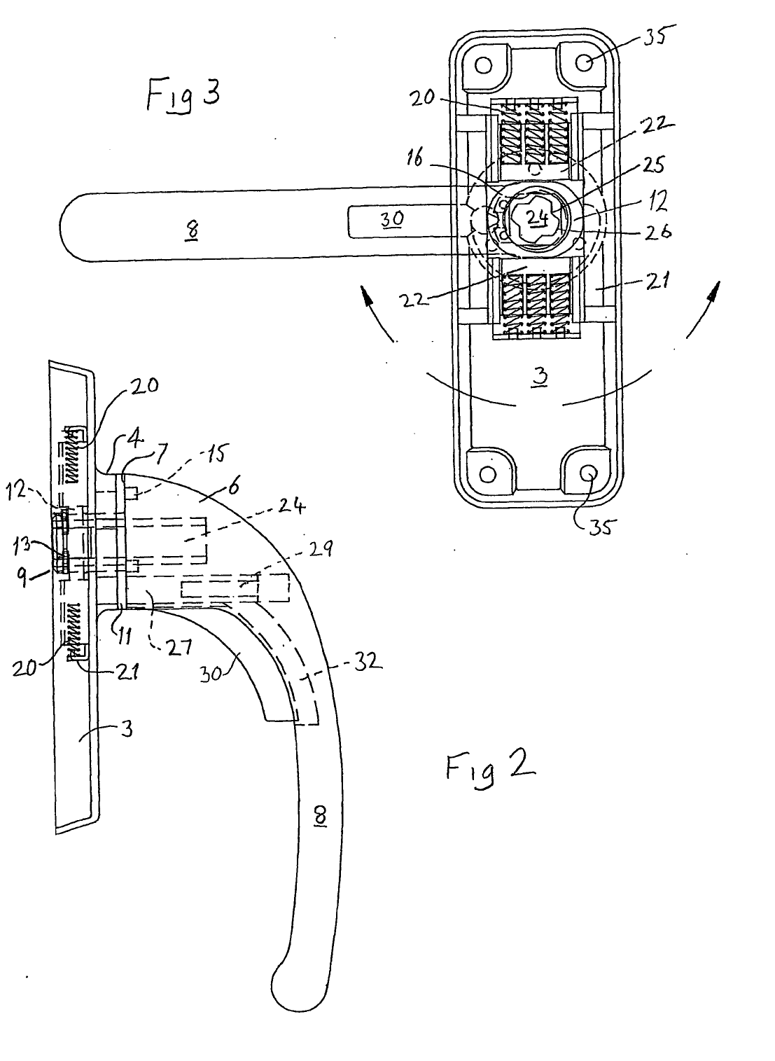

The locking mechanism illustrated in FIGS. 1 to 7 is designed for use with the latch spindle of a door latch inset within the body of a door between opposite sides of the door. The latch spindle is of square cross section and projects from opposite sides of the door. A normal door handle or, alternatively, that illustrated in FIGS. 8, 9 and 10, may be fixed to the end of the latch spindle at one side of the door, normally the outside, and is constrained to turn in one direction for withdrawing the latch bolt. The locking mechanism is fitted to the end of the latch spindle on the inside of the door to permit the door to be locked from that side. As is conventional, the latch includes a spring loaded latch bolt which is resiliently urged into a projecting position for engaging a catch on the adjacent door jamb so as to latch the door in a closed position. The latch spindle is coupled to the latch bolt by a conventional mechanism which operates to retract or withdraw the latch bolt into the latch casing, and disengage it from a cooperating door catch, in response to turning of the latch spindle, thereby to permit the door to be opened.

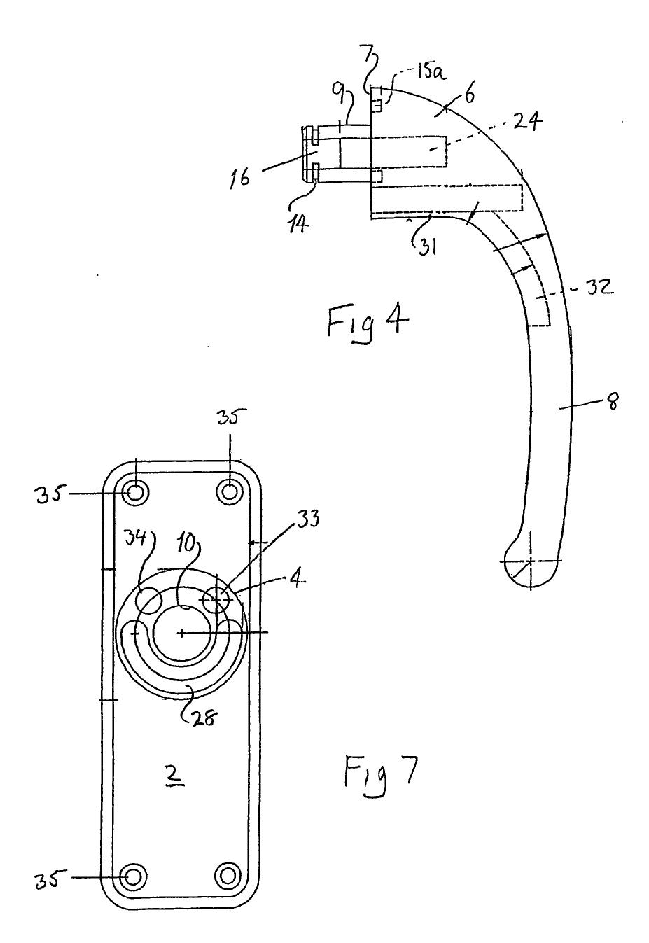

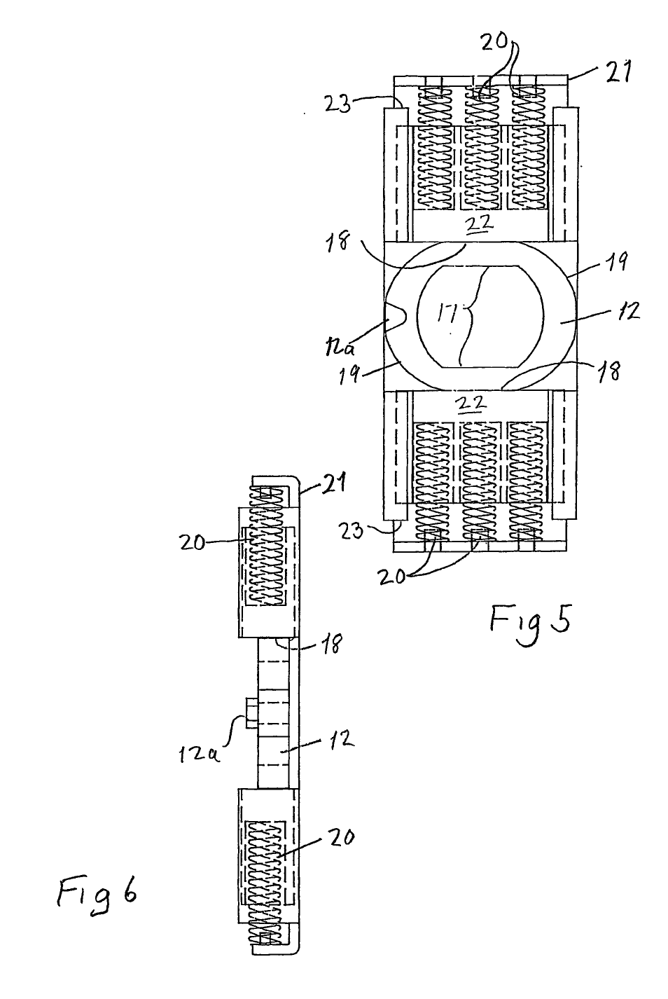

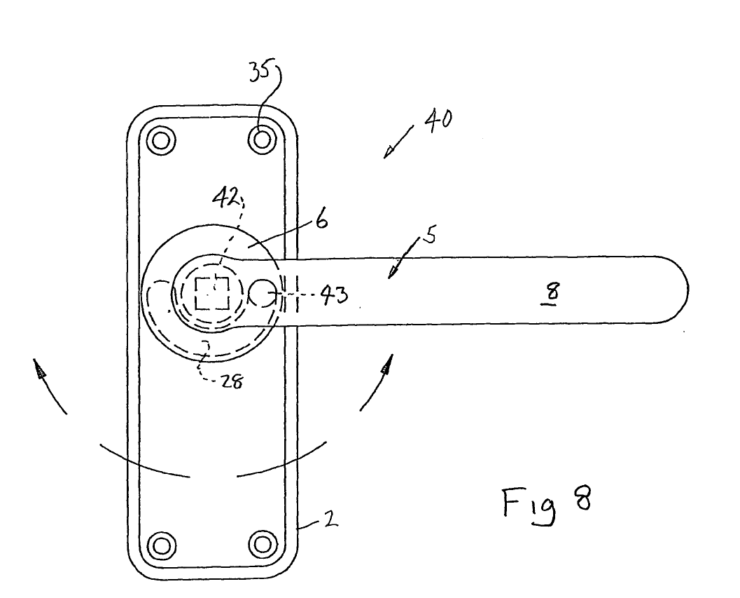

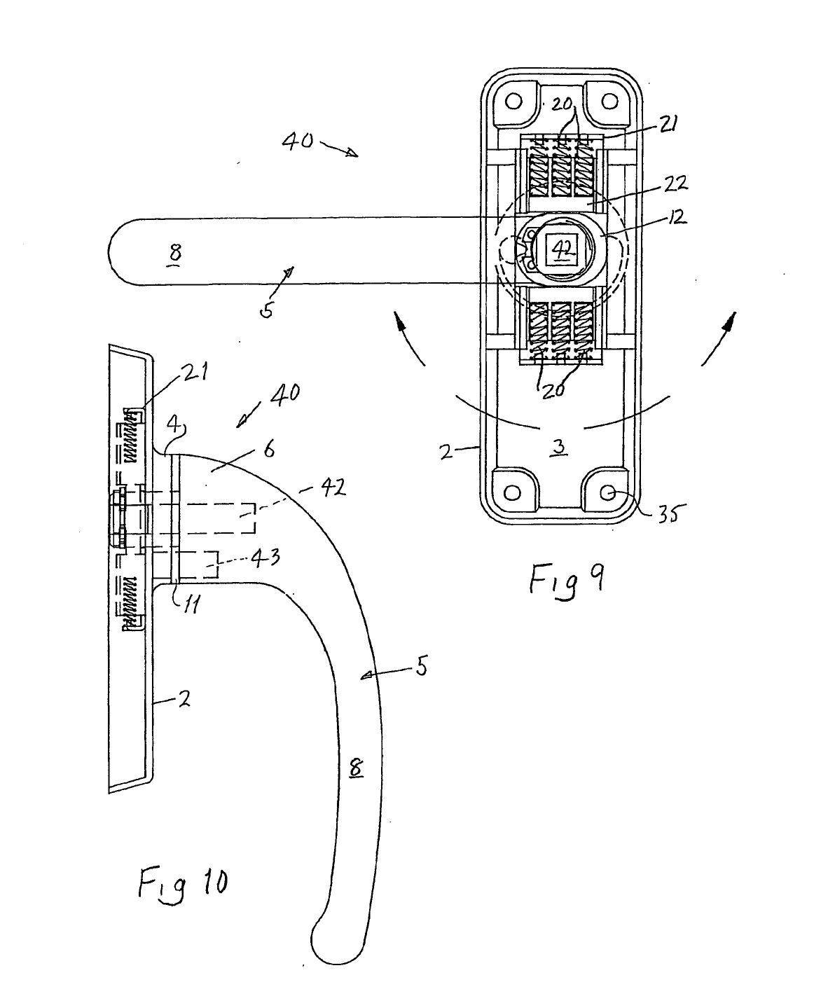

Referring to FIGS. 1 to 7, the locking mechanism 1 comprises a cast metal base plate 2 having a cavity 3 on its side adjacent the door for housing components of the mechanism and a circular boss 4 projecting on its outside. Journalled in the boss 4 is a door handle 5 comprising a body portion 6 which has an end 7 adjacent the boss of the same diameter as the latter and is suitably radiused so as to lead into a lever portion 8 at its opposite end extending generally transverse to the axis of the boss. The handle is journalled in the boss 4 via a stub shaft 9 (FIG. 4) projecting from the adjacent end 7 of the handle and rotatably mounted in a cooperating opening 10 in the boss. A special washer 11 is disposed about the stub shaft between the boss and the end 7 of the handle, and a cam 12 is fitted onto the end of the stub shaft projecting into the cavity 3 of the base plate. The handle is rotatably secured in position to the base plate by a circlip 13 engaged in a groove 14 in the projecting end of the stub shaft, on the inside of the cam. Free ends of the circlip engage in a V-notch 12a in the adjacent face of the cam 12. The washer 11 has three small stubs 15 equally spaced thereabout and engaging in cooperating holes 15a in the adjacent end of the body portion 6 of the handle so that it is rotatable with the handle.

The end of the stub shaft 9 projecting into the cavity 3 of the base plate is formed with diametrically opposite flats 16 parallel to the direction in which the handle lever 8 projects, and the cam 12 is formed with cooperating flats 17 so that the cam turns with the handle (FIGS. 5 and 6). The outer periphery of the cam has flats 18 parallel with the flats 17 on its inner periphery and interconnected by circular sections 19 so that the outer periphery of the cam is of generally elliptical shape. The diametrically opposite flats 18 on the outer periphery of the cam are acted upon by banks of three compression springs 20 contained in a cassette 21 which is removably housed in the cavity 3 of the base plate. This spring cassette, which is a device commonly used in door handle products, is attached to the inside of the base plate about the stub shaft 9. Each bank of springs 20 acts on the adjacent flat 18 via a bar shaped follower 22 slidably guided at opposite ends in guide grooves 23 of the cassette. The spring loaded followers 22 act on the flats 18 resiliently to urge the handle into a rest position in which the handle lever 8 is generally horizontal.

To enable the handle 5 to be fitted to the adjacent projecting end of the latch spindle, the handle has a blind drive passageway 24 extending coaxially of the stub shaft 9 from the inner end thereof and into the body portion 6 of the handle. This passageway has a specially designed internal profile. It is axially fluted and comprises four ribs 25 and grooves 26 symmetrically spaced about the periphery of the passageway and arranged so as to enable the handle to have a predetermined degree of rotational freedom relatively to the latch spindle when engaged with the latter. The bottom of each of the grooves 26, in cross section, has an arcuate periphery of a diameter substantially corresponding to the length of the diagonal of the square section of the cooperating end of the latch spindle so that the handle can turn relatively to the latch spindle in opposite directions through a predetermined arc of movement, at opposite ends of which, the ribs 25 engage the square section latch spindle.

Mounted in the body portion of the handle so as to be slidable along an axis parallel to the journal axis of the handle is a locking member or rod 27 of circular cross section. The locking member extends through a cooperating hole in the washer 11 and its projecting end engages in a semicircular groove 28 which is formed in the adjacent surface of the boss 4 of the base plate (FIG. 7) and is substantially coaxial with the journal of the stub shaft 9. It is resiliently urged into engagement with this groove by a compression spring 29 housed in the body portion 6 of the handle and acting on the opposite end of the locking member. The latter is controlled by a trigger portion 30 integral with the locking member and which projects through an axial slot 31 in the body portion 6 and extends juxtaposed the lever portion 8 of the handle in a convenient position for manual operation by a person gripping the lever portion. The slot in the body portion leads into a slot 32 in the lever portion 8 and into which the trigger 30 can retract to enable the locking member to be withdrawn when the trigger is depressed by the person gripping the handle.

To enable the handle 5 to be locked against turning, two retainer holes 33, 34 engageable by the locking member 27 are formed in the surface of the boss 4 adjacent the handle, at positions above opposite ends of the semicircular groove 28. The arcuate distance of these retainer holes above the ends of the groove 28 and the angle subtended by the arcuate bottom periphery of each of the grooves 26 in the fluted drive passageway 24 depends on the angle over which the handle must be turned to fully withdraw the associated latch bolt to permit opening of the door. In the present embodiment, the angles are illustrated as being approximately 45°. However, it may be desirable to increase this angle to, for example, 60°, to achieve proper withdrawal of the latch bolt on turning of either door handle.

The angle of movement over which the handle may be turned so as to turn a cooperating latch spindle and withdraw the latch bolt is defined by the arcuate groove 28 and the locking member 27 may be selectively engaged in the retainer holes 33, 34 by depressing the trigger 30, when the locking member 27 is at either end of the groove 28. This withdraws the projecting end of the locking member from the groove 28 and permits the handle to be turned upwardly beyond opposite ends of the groove and engage in the selected hole 33, 34.

The base plate 2 has through holes 35 via which the locking mechanism 1 can be fixed to the side of the door which is to be lockable to prevent access from the opposite side. Normally, this will be what is considered to be the inside of the door. The opposite, outside of the door may be provided with any suitable type of handle for actuating the latch mechanism and which has a square section passageway for fitting to the adjacent end of the square section latch spindle so as to enable turning of the latter. The locking mechanism 1 is secured to the inside of the door, by screws inserted through the holes 35, with the passageway 24 in the handle fitted onto the adjacent end of the latch spindle. The locking mechanism is secured to the door so that, when the latch bolt is in its projecting, latching position, the handle lever 8 is in a horizontal rest position, into which it is urged by springs 20 acting on the cam 12, the locking member 27 abuts one end of the groove 28, and the square section of the latch spindle engages the axial ribs 25 of the fluted passageway 24. The end of the groove 28 engaged by the locking member in this rest position depends upon whether the handle lever 8 is mounted to the right or left hand of the base plate 2, for clockwise or anti-clockwise downward movement, to withdraw the latch bolt. In either event, with the ribs 25 of the fluted passageway engaging the latch spindle in the rest position, downward movement of the handle turns the latch spindle in a direction to withdraw the latch bolt from its latching position and permit opening of the latched door.

The fluted passageway 24 enables the handle 5 to freewheel or turn freely relatively to the latch spindle in opposite directions through a predetermined arc of movement so that, from the rest position in which the handle is engaged with the latch spindle, the handle can be turned in the opposite direction, after depressing the trigger 30 to withdraw the locking member 27 from the groove 28. Hence, the handle can then be turned in the upward direction, irrespective of whether it is right or left handed, and the locking member can be engaged in the adjacent retainer hole 33, 34, in which position the ribs 25 of the fluted passageway in the handle engage the latch spindle so as to prohibit turning thereof in a direction to withdraw the latch bolt, by the handle on the outside of the door. The handle on the outside is constrained to turn in that direction for withdrawing the latch bolt. The door can therefore be locked on the inside to prevent entry from the outside by simply depressing the trigger portion 30 of the locking member so that the latter can move past the end of the groove 28, and by lifting the handle lever to engage the locking member in the adjacent locking hole. To return the handle to its rest position and unlock the door, the trigger is again depressed to withdraw the locking member from the cooperating locking hole, after which the handle can be returned to its rest position assisted by the action of the springs 20 on the cam 12.

FIGS. 8, 9 and 10 illustrate a handle mechanism 40 for use with the locking mechanism 1 of FIGS. 1 to 7, on the opposite side or outside of the door. This handle mechanism is similar to the locking mechanism 1 except that the handle 5 has a square section drive passageway 42 for fitting with the adjacent end of the latch spindle and, instead of the locking member 27, it has a stop pin 43 which projects from the body portion 6 of the handle, through the hole in the washer 11 and engages in the semi-circular groove 28 in the adjacent surface of the boss 4. The stop pin and groove cooperate to constrain the handle to turning only in the lower arc of approximately 180 and prohibit the handle from being lifted beyond the ends of the groove. The construction of this handle mechanism, like the locking mechanism permits selective right or left handing of the lever portion 8 of the handle so that the lever portion projects horizontally from a rest position to the selected side of the base plate 2.

When the mechanisms 1 and 40 are supplied together as a set and capable of being selectively arranged for right or left handing, the set may include two latch spindles. One of these is a conventional square section latch spindle and the other is a two-part latch spindle 50, as shown in FIGS. 11 and 12. Both parts 51, 52 of the latter are of square section but one part 51 is twisted through 45 with respect to the other part 52 to allow for the change in relative position of the freewheel, fluted shape in the drive passageway of the locking mechanism when the handle 5 is required to work in the opposite hand.

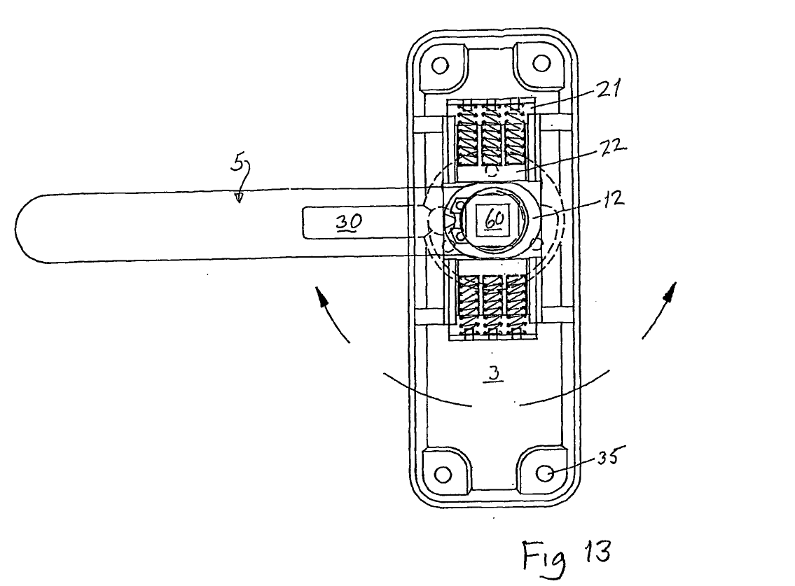

The outside handle for use with the locking mechanism of FIGS. 1 to 7, may be constructed with an emergency release where this is a requirement for the outside of a door such as a bathroom door. As shown in FIG. 13, this is achieved by making the outside handle mechanism of exactly the same construction as the locking mechanism 1 save for a square section drive passageway 60. When the handle 5 of the locking mechanism installed on the inside is locked, as described above, so that the outside handle cannot be moved downwardly to release the latch mechanism, in an emergency, the trigger 30 on the outside handle can be depressed to withdraw the locking member 27 from the cooperating groove 28, thus freeing the outside handle. It may then be lifted upwardly to rotate the latch spindle, withdraw the latch bolt and unlock the door. The outside handle locks out when its locking member engages in a cooperating locking hole 33, 34, thereby ensuring that the latch bolt is retained in its retracted position until the outside handle is released and return to the horizontal rest position by actuating the outside trigger 30.

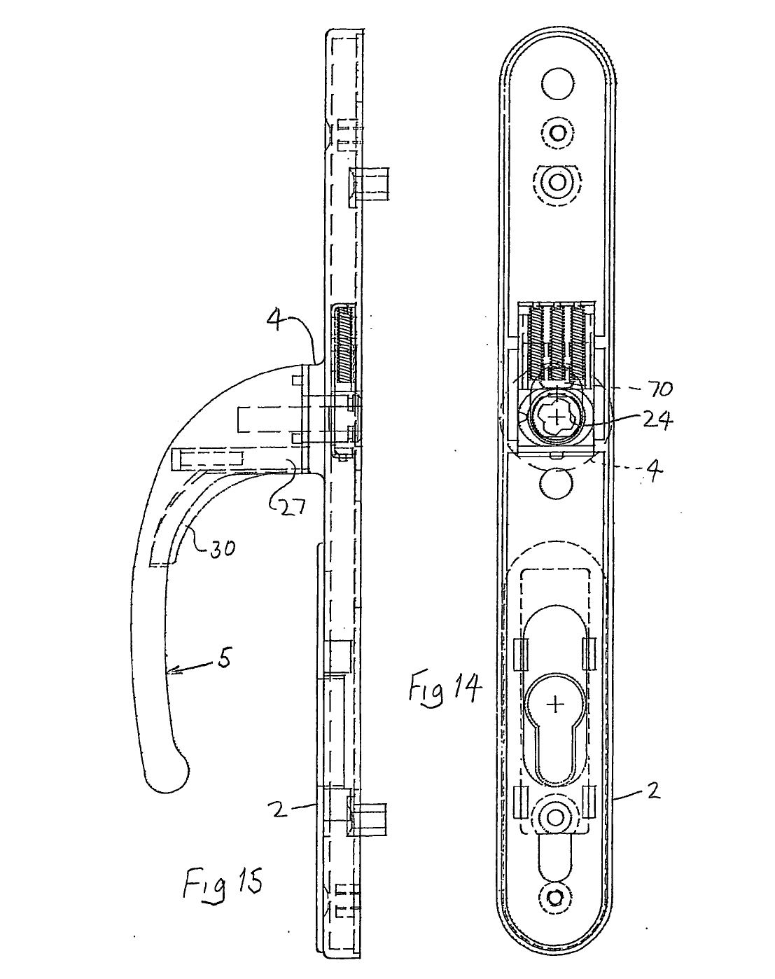

FIGS. 14 and 15 illustrate an embodiment of the invention for use with sliding patio doors where the handles on opposite sides of the door can be lifted through 45° from a horizontal position to cause a series of bolts and latches to project from the door frame and engage the door jamb. This embodiment is of similar construction to that described with reference to FIGS. 1 to 7 except that there is no semi-circular guide groove 28 and, instead of two locking or retainer holes for the locking member 27 disposed at angles of between 45° and 60° above the axis of the handle journal, a single locking hole in the form of an arcuate slot 70 and subtending an angle of about 10°, is disposed in the boss 4 of the base plate at a position vertically above the axis of the handle journal. The projecting end of the locking member 27 normally slides against the adjacent surface of the base plate boss 4 until it snaps in, to the locking slot 70. The operation of this embodiment is as follows. By lifting an internal handle 5 through 45°, the freewheel shape defined by the fluted passageway 24 in the internal handle is taken up and the drive is transmitted to the latch spindle. Thereafter, rotation of the handle to the 90° position enables the locking member to engage in the locking slot 70 so that the door is locked with the handle on the outside raised to the 45° position, thereby indicating that the door is deadlocked.

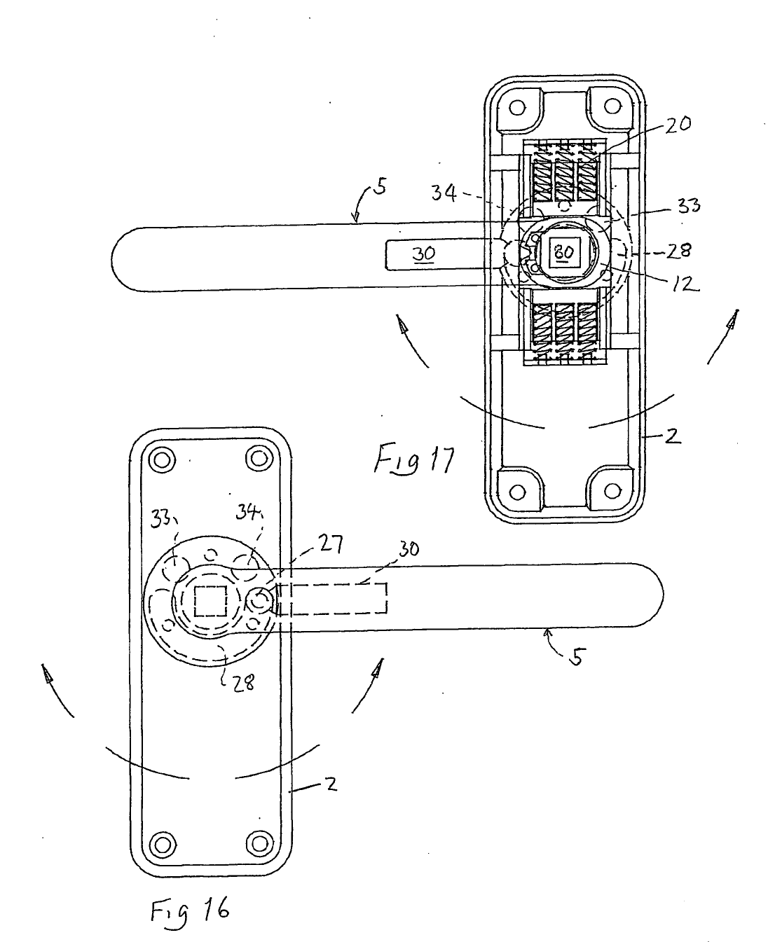

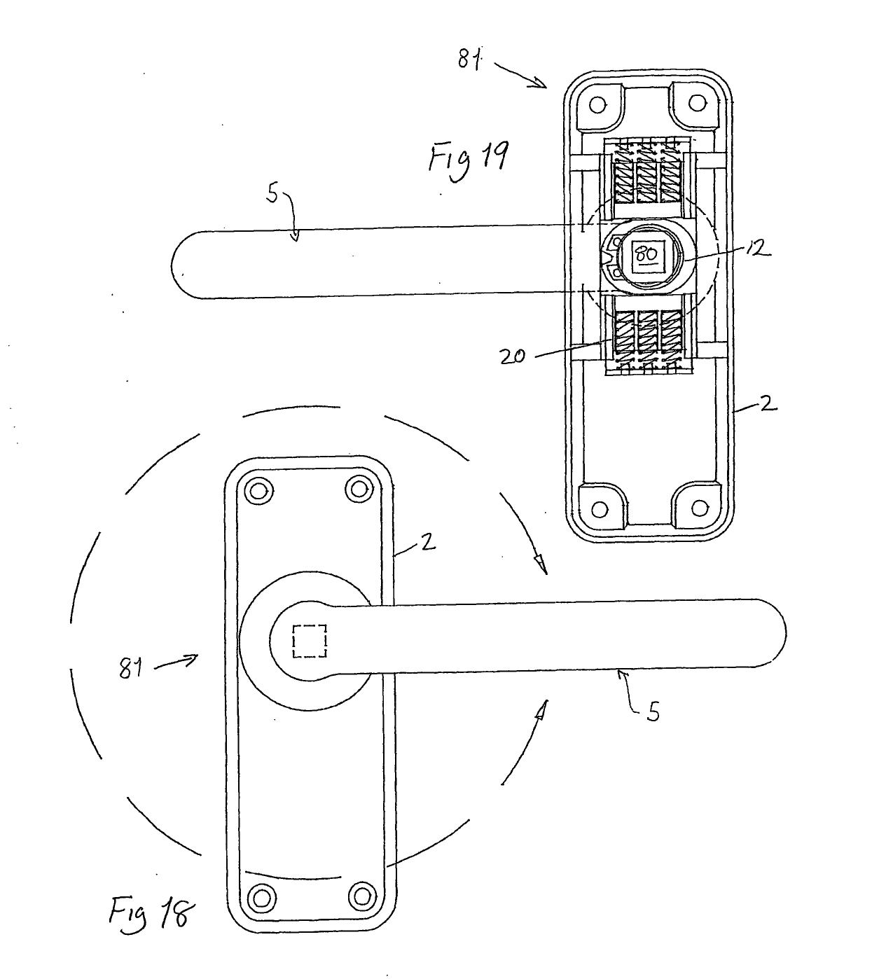

In the embodiment illustrated in FIGS. 16 to 19, the handle 5 of the locking mechanism (FIGS. 16 and 17) has a square drive passageway 80 for fitting to the adjacent end of a latch spindle in place of the fluted passageway of the previous embodiments. Otherwise, the construction of this locking mechanism is similar to those previously described. As illustrated in FIGS. 18 and 19, the handle mechanism 81 for use with the locking mechanism of FIGS. 16 and 17 on the opposite side or outside of the door is similar to the locking mechanism except that the locking member 27, semi-circular guide groove 28 and retainer holes 33, 34 are omitted. Hence, as there is no restriction on the side with the mechanism 81, its handle 5 can rotate freely through 360. Internally, on the side of the locking mechanism, when the trigger 30 of the locking member 27 is depressed and the handle 5 of the locking mechanism is lifted through 45°, the square latch spindle is rotated so lifting the handle on the opposite side of the door. The rotation of the latch spindle operates the cam of the latch mechanism which locks the latch out. When the locking member is engaged in the relevant retainer hole 33, 34, the door is locked and the handle 5 of the external mechanism 81 cannot be turned to open the door.

1-15. (canceled)

16. A locking mechanism for a latch mechanism having a latch spindle turnable to move a latch bolt from its latching position, the locking mechanism comprising:
a rotatable handle having a drive passageway therein for fitting to an adjacent end of the latch spindle; and
a locking member mounted on the handle; and
a retainer associated and engageable with the locking member to lock the handle against rotation;
the drive passageway being configured to allow the handle to turn relatively to the latch spindle in opposite directions through a predetermined angle of movement, at one end of which, the handle is engageable with the latch spindle for turning the latch spindle in an opening direction to move the latch bolt from its latching position and, at the opposite end of which, the handle is in a locking position in which the locking member is engageable with the retainer and the handle is engageable with the spindle to prohibit turning of the spindle in the opening direction.

17. The locking mechanism as claimed in claim 16, wherein the locking member is slidably mounted in the handle and is selectively controllable to be engaged with and disengaged from the retainer.

18. The locking mechanism as claimed in claim 17, wherein the locking member has a control device projecting closely adjacent the handle in a convenient position for manual operation by a person gripping the handle, and the locking member is resiliently urged towards a position in which it is engageable with the retainer.

19. The locking mechanism as claimed in claim 16, further comprising a guide defining an arc of movement for the locking member when the handle is turned in the opening direction from its rest position.

20. The locking mechanism as claimed in claim 19, further comprising a spring device biasing the handle to a rest position corresponding to the one end of the angle of movement defined by the drive passageway; the guide including a stop engageable by the locking member to define the rest position and the retainer being disposed in spaced relation to the stop in the opposite direction to that in which the handle is turnable from its rest position to turn the latch spindle in the opening direction.

21. The locking mechanism as claimed in claim 20, wherein the retainer comprises a hole with which a projecting end of the locking member is engageable to lock the handle in its locking position; wherein the guide comprises an arcuate groove along which the projecting end of the locking member moves when the handle is turned from its rest position in the opening direction of the latch spindle; and wherein the stop defining the rest position of the handle comprises an end of the arcuate groove adjacent the retainer.

22. The locking mechanism as claimed in claim 21, wherein the handle comprises a lever arm which, in the rest position is arranged to be substantially horizontal, and wherein the retainer is disposed along the arc of movement of the locking member above the stop defining the rest position and at a position spaced about 45°-60° above the stop, whereby the lever arm is lifted to permit the locking member to engage with the retainer and lock the handle in its locking position.

23. The locking mechanism as claimed in claim 22, wherein the guide comprises a semi-circular guide to provide a stop and rest position at opposite ends of the guide, and wherein the retainer is adjacent opposite ends of the guide, whereby the handle may be fitted to provide for either clockwise or counterclockwise rotation for turning the handle from its rest position to move the latch spindle in the opening direction.

24. The locking mechanism as claimed in claim 16, further comprising a base plate securable to a door having the latch mechanism and mounting the retainer thereon; and wherein the handle is rotatably mounted in the base plate.

25. The locking mechanism as claimed in claim 16, wherein the drive passageway in the handle is axially fluted and includes an internal cross-section comprising ribs and grooves symmetrically spaced about the internal periphery of the passageway and arranged to allow the handle to have a predetermined degree of rotational freedom relative to the latch spindle when engaged therewith.

26. The locking mechanism as claimed in claim 25, wherein the bottom periphery of each of the grooves semi-circular in cross-section having a diameter substantially corresponding to a length of a diagonal of a square section of the adjacent end of the latch spindle so that the handle can turn relatively to the latch spindle in opposite directions through the predetermined angle of movement, at opposite ends of which, the ribs engage the square section latch spindle.

27. The locking mechanism as claimed in claim 16, further comprising a second handle having a passageway therein for fitting to the end of the latch spindle opposite to that fitted with the locking member.

28. The locking mechanism as claimed in claim 27, wherein the latch spindle comprises a two-part latch spindle, both parts of which are of square section with one part twisted with respect to the other to accommodate a change in relative positions with the drive passageway.

29. A latch mechanism comprising:
a latch spindle;
a latch bolt movable from a latching position to a release position in response to turning of the latch spindle; and
a locking mechanism comprising
a rotatable handle having a drive passageway therein fitted to an adjacent end of the latch spindle, and
a locking member mounted on the handle, and
a retainer associated and engageable with the locking member to lock the handle against rotation,
the drive passageway being configured to allow the handle to turn relatively to the latch spindle in opposite directions through a predetermined angle of movement, at one end of which, the handle is engageable with the latch spindle for turning the latch spindle in an opening direction to move the latch bolt from its latching position and, at the opposite end of which, the handle is in a locking position in which the locking member is engageable with the retainer and the handle is engageable with the spindle to prohibit turning of the spindle in the opening direction.

30. The latch mechanism as claimed in claim 29, wherein the locking member is slidably mounted in the handle and is selectively controllable to be engaged with and disengaged from the retainer.

31. The latch mechanism as claimed in claim 30, wherein the locking member has a control device projecting closely adjacent the handle in a convenient position for manual operation by a person gripping the handle, and the locking member is resiliently urged towards a position in which it is engageable with the retainer.

32. The latch mechanism as claimed in claim 29, further comprising a guide defining an arc of movement for the locking member when the handle is turned in the opening direction from its rest position.

33. The locking mechanism as claimed in claim 32, further comprising a spring device biasing the handle to a rest position corresponding to the one end of the angle of movement defined by the drive passageway; the guide including a stop engageable by the locking member to define the rest position and the retainer being disposed in spaced relation to the stop in the opposite direction to that in which the handle is turnable from its rest position to turn the latch spindle in the opening direction.

34. A locking mechanism for a latch mechanism having a latch spindle turnable to move a latch bolt from a latching position, the locking mechanism comprising:
a rotatable handle for fixing to an adjacent end of the latch spindle for turning the latch spindle;
a locking member mounted on the handle;
a retainer associated and engageable with the locking member, in a locking position of the handle, to prohibit turning of the handle and the latch spindle;
a guide spaced from the locking position and delimiting an arc of movement of the locking member when the handle is turned from a rest position to move the latch bolt from its latching position; and
an actuator for operating the locking member to permit the handle to be turned from the rest position to the locking position and the locking member to be engageable with the retainer.

35. The locking mechanism as claimed in claim 34, wherein the locking member is slidably mounted in the handle and is selectively controllable to be engaged with and disengaged from the retainer.

36. The locking mechanism as claimed in claim 34, further comprising a base plate securable to a door having the latch mechanism and mounting the retainer thereon; and wherein the handle is rotatably mounted in the base plate.
